(19) United States
(12) Patent Application Publication
(10) Pub. No.: US 2009/0253024 A1
(43) Pub. Date: Oct. 8, 2009

(54) Nitro-Compound Cathodes for Batteries and Semi-Fuel Cells

(75) Inventors: Daniel A. Buttry, Tempe, AZ (US); Jessica Mitchell, Lake Forest Park, WA (US)

Correspondence Address: JEFFREY B. OSTER, 8339 SE 57TH ST, MERCER ISLAND, WA, 98040, US

(73) Assignee: Nanomaterials Discovery Corporation

(21) Appl. No.: 12/399,971

(22) Filed: Mar. 8, 2009

Related U.S. Application Data
(60) Provisional application No. 61/034,956, filed on Mar. 8, 2008.

(51) Int. Cl. H01M 4/02; H01M 4/60

(52) U.S. Cl. 429/42; 429/213

(57) ABSTRACT

There is disclosed a cathode/fuel formulation used for primary cells (batteries) or even for semi-fuel cells. More particularly, there is disclosed an air-breathing cathode semi-fuel cell having an anode and a cathode formulation, wherein the anode comprises a formulation of metals and alloys selected from the group consisting of Li, Mg, Ca, Al, and combinations thereof, and the cathode formulation comprises components (a) an aromatic nitro compound as a fuel, (b) a binder agent, and (c) and a conductive particle composition, wherein the three components are mixed together and pressed onto a scaffold to form a cathode, wherein the cathode formulation further comprises oxygen or openings to allow for air to circulate. More particularly, there is disclosed a battery having an anode and a cathode formulation, wherein the anode comprises a formulation of metals and alloys selected from the group consisting of Li, Mg, Ca, Al, and combinations thereof, and the cathode formulation comprises components (a) an aromatic nitro compound as a fuel, (b) a binder agent, and (c) and a conductive particle composition, wherein the three components are mixed together and pressed onto a scaffold to form a cathode.

The present invention was made under U.S. Army contract DAAE 30-01-9-0800 TOSA58. The government has certain rights to this invention.

### TECHNICAL FIELD

This disclosure provides a cathode/fuel formulation used for primary cells (batteries) or even for semi-fuel cells. More particularly, this disclosure provides an air-breathing cathode semi-fuel cell having an anode and a cathode formulation, wherein the anode comprises a formulation of metals and alloys selected from the group consisting of Li, Mg, Ca, Al, and combinations thereof, and the cathode formulation comprises components (a) an aromatic nitro compound as a fuel, (b) a binder agent, and (c) and a conductive particle composition, wherein the three components are mixed together and pressed onto a scaffold to form a cathode, wherein the cathode formulation further comprises oxygen or openings to allow for air to circulate. More particularly, the present disclosure provides a battery having an anode and a cathode formulation, wherein the anode comprises a formulation of metals and alloys selected from the group consisting of Li, Mg, Ca, Al, and combinations thereof, and the cathode formulation comprises components (a) an aromatic nitro compound as a fuel, (b) a binder agent, and (c) and a conductive particle composition, wherein the three components are mixed together and pressed onto a scaffold to form a cathode.

### BACKGROUND

A fuel cell is an electrochemical device that converts chemical energy into electrical energy. In terms of such energy conversion, fuel cells may look similar to batteries and combustion engines that are used to generate electrical energy. But unlike batteries, fuel cells can produce electricity as long as they are supplied with a fuel. Besides, in contrast to combustion engines, fuel cells can produce electricity directly from electrochemical reactions without multiple energy conversions, including heat and mechanical motions. In a typical fuel cell, a fuel, usually hydrogen, is provided to the anode and oxidized, releasing protons and electrons. The generated electrons pass through an external load to do electrical work and travel back to the cathode, whereas the protons migrate across the electrolyte to the cathode. In the cathode, an oxidant, usually oxygen in the air, is supplied and reduced with the protons and electrons, creating pure water as a by-product. Therefore fuel cells or semi-fuel cells have air or another oxidant supplied to the cathode where it is reduced.

Batteries or primary cells are devices which convert stored chemical energy directly into electrical energy by an electrochemical process. Generally, the term primary cell refers to the class of cells in which the chemical reactions are not efficiently reversible. Cells with magnesium anodes yield considerable electrical energy per unit of cell volume and weight.

The reduction of nitro compounds to produce an electrical current has been done for over 100 years. For example, U.S. Pat. No. 736,205 (issued 11 Aug. 1903) describes the reduction of nitrobenzene by addition of lead chloride to a cathode electrolyte having a Pt electrode. Nitrobenzene was also reduced in a cathode electrolyte solution with the addition of metallic lead. Further, U.S. Pat. No. 700,672 (filed 24 Sep. 1900) describes current formation by the reduction of nitrobenzene by the addition of cuprous chloride or copper powder to a cathode electrolyte solution.

The history of fuel cells can be traced back to the early 1800s. The judge and scientist, Sir William Robert Grove, discovered that if electricity could split water into hydrogen and oxygen, then the opposite would also be possible such that combining hydrogen and oxygen in some way would produce electricity (Blomen and Mugerwa, Fuel Cell Systems, New York and London: Plenum Press, 1993; and Hoogers, Fuel Cell Technology Handbook, Boca Raton: CRC Press, 2002). To test this hypothesis, Grove enclosed two platinum strips in separate sealed glass tubes; one contained hydrogen and the other contained oxygen. Once these containers were dipped into a dilute sulfuric acid solution, a current began to flow between the two electrodes and the water was formed in the oxygen glass tube. Grove connected several of these devices in series and completed what he referred to as a “gas battery” in 1839.

About 50 years later, the chemists, Ludwig Mond and Charles Langer, coined the term “fuel cell,” as they attempted to develop the device that could convert coal or carbon into electricity (Blomen and Mugerwa, Fuel Cell Systems, New York and London: Plenum Press, 1993). In 1952, Francis Thomas Bacon, developed the first successful fuel cell using hydrogen, oxygen, an alkaline electrolyte, and nickel electrodes—inexpensive alternatives to the catalysts used before such as platinum. Bacon and his coworker demonstrated a fuel cell capable of producing the maximum output power of 5 kW, enough to power a welding machine (Blomen and Mugerwa, Fuel Cell Systems, New York and London: Plenum Press, 1993; and Hoogers, Fuel Cell Technology Handbook, Boca Raton: CRC Press, 2002). In the late 1950s, the National Aeronautics and Space Administration (NASA) were looking for a compact and efficient electricity generator for use on space missions. NASA had already concluded that for this purpose nuclear power was too dangerous, batteries were too heavy, and solar power was too expensive, and thus began to search for an alternative. In the end, the fuel cell was chosen as a possible solution, and NASA soon proceeded with a number of research works to develop fuel cells suitable for spacecraft.

Lithium batteries are integrated solid state systems that often combine a polymeric membrane possessing ionic conductivity with one Li electrode and one Li+ inserting electrode (oxide, etc). The polymeric membrane acts as an ion conductor and as an electrode separator. The polymeric membrane normally consists of a high molecular weight polymer containing heteroatoms either in its main chain or lateral branches (for example, polyethylene oxide) in which a Li salt has been dissolved (such as LiCLO₄ and LiAsF₆). The negative electrode generally consists of a Li metal film, and positive electrode is based on a reversible intercalation compound which is incorporated into a polymer of the same composition as the material used as the polymeric electrode, together with a small amount of an electronic conductor material, such as carbon black.

Organic nitro compounds have been used as cathode materials for primary batteries. Various nitro compounds have been reported for cathode performance in zinc- and magnesium-based cells. For example, m-dinitrobenzene has been investigated (Glicksman et al., J. Electrochem. Soc. 105:295, 1958; and Sivashanmugam et al. Abstr. Proc. Meet. Abstract No. 101, The Electrochem. Soc. Honolulu, Hi., USA, 16-21 p. 151, 1993), alkyl-substituted dinitro benzenes (Sivasamy et al., J. Power Sources, 25:295, 1989), p-nitrotoluene (Gopukumar et al., J Power Sources, 39:121, 1992; and Endrey et al., Proc. 22^{nd} Ann. Power Sources Conf. p. 51, 1968), 1-nitronaphthaline (Thirunakaren et al., J. Power Sources, 58:213-215, 1996), p-nitrophenol (Kumar et al. J. Electrochem. Soc. 140:3087, 1993), p-nitroaniline (Kumar et al., J. Appl. Electrochem. 23:265, 1993), picric acid and trinitrostilbene (Renuka et al., Proc. 6^{th} Int. Symp. Adv. Electrochem. Sci. Tech. SAEST, Chennai, India, 1998) have been investigated for their cathode performance in zinc and magnesium based cells. Renuka (J. Appl. Electrochem. 30:483-490, 2000) used 2-nitrophenyl pyruvic acid as a cathode material in a magnesium/zinc-based primary cell. 2-Nitrophenyl pyruvic acid is electro-reduced and cyclized to indole which is acted upon by oxygen to form anthranilic acid. Renuka (J. Power Sources 87:4-11, 2000) also tried 2-β-dinitrostyrene as a cathode material. Further Muniyandi et al. (J. Power Sources 45:119-130, 1993) looked at chloro-substituted dinitrobenzene as a cathode material.

Organic compounds have high theoretical coulombic capacities because they involve up to twelve electron transfer. Several organic compounds (e.g., p-nitrotoluene, p-chloronitrobenzene, p-nitroanaline, p-nitrophenol and p-nitrobenzoic acid) have been investigated as cathode depolarizers in magnesium primary reserve cells. In addition, the performance characteristics of 1-nitronaphthalene as a cathode material in magnesium primary reserve cells that use 2 M magnesium electrolytes at different discharge rates of 25 to 100 mA (Thirunakaran et al., J. Power Sources 58:213-215, 1996).

Therefore, there is a need in the battery and semi-fuel cell art to design more reliable cells with less expensive materials that provide power for longer periods of time and better current densities. The present disclosure was made to accomplish those goals.

### SUMMARY

The present disclosure provides a semi-fuel cell or battery cathode formulation comprising components (a) an aromatic nitro compound as a fuel, (b) a binder agent, and (c) and a conductive particle composition, wherein the three components are mixed together and pressed onto a scaffold to form a cathode. Preferably, the aromatic nitro composition is an aromatic compound having at least one benzyl ring structure and from one to about 8 nitro (—NO₂) moieties. More preferably, the aromatic nitro composition having one or a plurality of fused benzyl rings, wherein when there is one benzyl group the compound is a compound selected from the group consisting of mono-, di-, or tri-nitrobenzene or nitrotoluene or nitro alkyl (C-16) benzyl or nitrobenzonitrile or nitrobenzotrifluoride or nitrobenzoic acid or nitrobenzenesulfonic acid; m- or p-nitro benzamine or benzoic acid, and combinations thereof, or when there is a plurality of fused rings, the compound is selected from the group consisting of one or a plurality of nitro moieties on a napththalene, anthracene and combinations thereof. Most preferably, the aromatic nitro compound is selected from the group consisting of 3,5-dinitrobenzamide, 2,6-dinitrobenzaldehyde, 1,2-dinitrobenzene, 1,3-dinitrobenzene, 1,4-dinitrobenzene, 2,4-dinitrobenzenesulfonic acid, 2,4-dinitrobenzoic acid, 3,5-dinitrobenzoic acid, 2,4-dinitrobensonitrile, 3,5-dinitrobenzonitrile, 2,5-dinitrobenzotrifluoride, and combinations thereof. Preferably, the binder agent is present in an amount of from about 2% to about 10% by weight. Preferably, the binder agent is selected from the group consisting of PEG (polyethylene glycol), PTFE (Teflon), other polyfluorinated elthylene polymers, n-methylpyrrolidone, conductive polymers such as polythiophenes, polypyrrolidones, polymers impregnated with organic solvents such as polyvinylidene fluoride impregnated with ethylene carbonate, carbonates, and combinations thereof. Preferably, the conductive particle composition is selected from the group consisting of carbon, MnO₂, Vd oxide, and combinations thereof. More preferably, when the conductive particle composition is carbon, it present at an amount of from about 25% to about 40% by weight. More preferably, when the conductive particle composition is MnO₂ or Vd oxide or a combination of both present at an amount of from about 5% to about 10% by weight, the amount of carbon is from 0% to about 10% by weight.

Preferably, the cathode formulation further comprises a species that provides protons to the nitro groups to effect their reduction into amine groups. Most preferably, the species that provides protons to the nitro groups is selected from the group consisting of water, mono or di (hydroxyl) C1-6 alkyl alcohols, boric acid, acetic acid, citric acid, maleic acid, malic acid, acid-treated aluminum oxide, and combinations thereof.

Preferably, the cathode formulation further comprises a low or high molecular weight additive that serves to promote the transport of ionic species throughout the cathode. Most preferably, the low or high molecular weight additive that serves to promote the transport of ionic species throughout the cathode is selected from the group consisting of polyethylene oxide, polyethylene glycols, diglyme, tetraglyme, crown ethers, and combinations thereof.

Preferably, the cathode formulation further comprises a solid salt to provide for higher ionic conductivity within the cathode. Most preferably, the solid salt to provide for higher ionic conductivity within the cathode is selected from the group consisting of NaCl, Mg(ClO₄)₂, LiClO₄, MgCl₂, MgBr₂, LiF, LiCl, NaF, NaClO₄, and combinations thereof.

Preferably, the cathode formulation further comprises oxygen or openings to allow for air to circulate.

The present disclosure provides a battery having an anode and a cathode formulation,

wherein the anode comprises a formulation of metals and alloys selected from the group consisting of Li, Mg, Ca, Al, and combinations thereof, and the cathode formulation comprises components (a) an aromatic nitro compound as a fuel, (b) a binder agent, and (c) and a conductive particle composition, wherein the three components are mixed together and pressed onto a scaffold to form a cathode. Preferably, the aromatic nitro composition is an aromatic compound having at least one benzyl ring structure and from one to about 8 nitro (—NO₂) moieties. More preferably, the aromatic nitro composition having one or a plurality of fused benzyl rings, wherein when there is one benzyl group the compound is a compound selected from the group consisting of mono-, di-, or tri-nitrobenzene or nitrotoluene or nitro alkyl (C-16) benzyl or nitrobenzonitrile or nitrobenzotrifluoride or nitrobenzoic acid or nitrobenzenesulfonic acid; m- or p-nitro benzamine or benzoic acid, and combinations thereof, or when there is a plurality of fused rings, the compound is selected from the group consisting of one or a plurality of nitro moieties on a napththalene, anthracene and combinations thereof. Most preferably, the aromatic nitro compound is selected from the group consisting of 3,5-dinitrobenzamide, 2,6-dinitrobenzaldehyde, 1,2-dinitrobenzene, 1,3-dinitrobenzene, 1,4-dinitrobenzene, 2,4-dinitrobenzenesulfonic acid, 2,4-dinitrobenzoic acid, 3,5-dinitrobenzoic acid, 2,4-dinitrobensonitrile, 3,5-dinitrobenzonitrile, 2,5-dinitrobenzotrifluoride, and combinations thereof. Preferably, the binder agent is present in an amount of from about 2% to about 10% by weight. Preferably, the binder agent is selected from the group consisting of PEG (polyethylene glycol), PTFE (Teflon), other polyfluorinated elthylene polymers, n-methylpyrrolidone, conductive polymers such as polythiophenes, polypyrrolidones, polymers impregnated with organic solvents such as polyvinylidene fluoride impregnated with ethylene carbonate, carbonates, and combinations thereof. Preferably, the conductive particle composition is selected from the group consisting of carbon, MnO₂, Vd oxide, and combinations thereof. More preferably, when the conductive particle composition is carbon, it present at an amount of from about 25% to about 40% by weight. More preferably, when the conductive particle composition is MnO₂ or Vd oxide or a combination of both present at an amount of from about 5% to about 10% by weight, the amount of carbon is from 0% to about 10% by weight.

Preferably, the cathode formulation further comprises a species that provides protons to the nitro groups to effect their reduction into amine groups. Most preferably, the species that provides protons to the nitro groups is selected from the group consisting of water, mono or di (hydroxyl) C1-6 alkyl alcohols, boric acid, acetic acid, citric acid, maleic acid, malic acid, acid-treated aluminum oxide, and combinations thereof.

Preferably, the cathode formulation further comprises a low or high molecular weight additive that serves to promote the transport of ionic species throughout the cathode. Most preferably, the low or high molecular weight additive that serves to promote the transport of ionic species throughout the cathode is selected from the group consisting of polyethylene oxide, polyethylene glycols, diglyme, tetraglyme, crown ethers, and combinations thereof.

Preferably, the cathode formulation further comprises a solid salt to provide for higher ionic conductivity within the cathode. Most preferably, the solid salt to provide for higher ionic conductivity within the cathode is selected from the group consisting of NaCl, Mg(ClO₄)₂, LiClO₄, MgCl₂, MgBr₂, LiF, LiCl, NaF, NaClO₄, and combinations thereof.

Preferably, the cathode formulation further comprises oxygen or openings to allow for air to circulate.

The present disclosure provides an air-breathing cathode semi-fuel cell having an anode and a cathode formulation, wherein the anode comprises a formulation of metals and alloys selected from the group consisting of Li, Mg, Ca, Al, and combinations thereof, and the cathode formulation comprises components (a) an aromatic nitro compound as a fuel, (b) a binder agent, and (c) and a conductive particle composition, wherein the three components are mixed together and pressed onto a scaffold to form a cathode, wherein the cathode formulation further comprises oxygen or openings to allow for air to circulate.

Preferably, the aromatic nitro composition is an aromatic compound having at least one benzyl ring structure and from one to about 8 nitro (—NO₂) moieties. More preferably, the aromatic nitro composition having one or a plurality of fused benzyl rings, wherein when there is one benzyl group the compound is a compound selected from the group consisting of mono-, di-, or tri-nitrobenzene or nitrotoluene or nitro alkyl (C-16) benzyl or nitrobenzonitrile or nitrobenzotrifluoride or nitrobenzoic acid or nitrobenzenesulfonic acid; m- or p-nitro benzamine or benzoic acid, and combinations thereof, or when there is a plurality of fused rings, the compound is selected from the group consisting of one or a plurality of nitro moieties on a napththalene, anthracene and combinations thereof. Most preferably, the aromatic nitro compound is selected from the group consisting of 3,5-dinitrobenzamide, 2,6-dinitrobenzaldehyde, 1,2-dinitrobenzene, 1,3-dinitrobenzene, 1,4-dinitrobenzene, 2,4-dinitrobenzenesulfonic acid, 2,4-dinitrobenzoic acid, 3,5-dinitrobenzoic acid, 2,4-dinitrobensonitrile, 3,5-dinitrobenzonitrile, 2,5-dinitrobenzotrifluoride, and combinations thereof. Preferably, the binder agent is present in an amount of from about 2% to about 10% by weight. Preferably, the binder agent is selected from the group consisting of PEG (polyethylene glycol), PTFE (Teflon), other polyfluorinated elthylene polymers, n-methylpyrrolidone, conductive polymers such as polythiophenes, polypyrrolidones, polymers impregnated with organic solvents such as polyvinylidene fluoride impregnated with ethylene carbonate, carbonates, and combinations thereof. Preferably, the conductive particle composition is selected from the group consisting of carbon, MnO₂, Vd oxide, and combinations thereof. More preferably, when the conductive particle composition is carbon, it present at an amount of from about 25% to about 40% by weight. More preferably, when the conductive particle composition is MnO₂ or Vd oxide or a combination of both present at an amount of from about 5% to about 10% by weight, the amount of carbon is from 0% to about 10% by weight.

Preferably, the cathode formulation further comprises a species that provides protons to the nitro groups to effect their reduction into amine groups. Most preferably, the species that provides protons to the nitro groups is selected from the group consisting of water, mono or di (hydroxyl) C1-6 alkyl alcohols, boric acid, acetic acid, citric acid, maleic acid, malic acid, acid-treated aluminum oxide, and combinations thereof.

Preferably, the cathode formulation further comprises a low or high molecular weight additive that serves to promote the transport of ionic species throughout the cathode. Most preferably, the low or high molecular weight additive that serves to promote the transport of ionic species throughout the cathode is selected from the group consisting of polyethylene oxide, polyethylene glycols, diglyme, tetraglyme, crown ethers, and combinations thereof.

Preferably, the cathode formulation further comprises a solid salt to provide for higher ionic conductivity within the cathode. Most preferably, the solid salt to provide for higher ionic conductivity within the cathode is selected from the group consisting of NaCl, Mg(ClO₄)₂, LiClO₄, MgCl₂, MgBr₂, LiF, LiCl, NaF, NaClO₄, and combinations thereof.

### BRIEF DESCRIPTION OF DRAWINGS

FIG. 1 shows an example of a discharge curve from the battery system of Example 1. The battery was discharged at a constant rate of 5 mA (green curve in the figure). Both the cathode and anode potentials were measured against an Ag/AgCl reference electrode containing 4 M KCl. The anode potential is shown in blue, and the cathode potential is shown in red. As can be seen, the anode potential remained relatively constant at approximately −1.35 V. The cathode potential initially was also relatively constant at −0.3 V. This indicates a fuel usage efficiency of about 30%.

FIG. 2 shows an example of a discharge curve from the battery system of Example 2. The battery was discharged at a constant current 1 mA (green curve in the figure). Both the cathode and anode potentials were measured against an Ag/AgCl reference electrode containing 4 M KCl. The anode potential is shown in blue, and the cathode potential is shown in red. As can be seen, the anode potential remained relatively constant at approximately −0.25 V and −0.45 V for approximately 60,000 seconds. The cathode potential initially was also relatively constant at −0.3 V. This indicates a fuel usage efficiency of about 30%.

FIG. 3 shows a graph of charge versus constant current (time) with two sets of disclosed battery systems operated at a high current (5 mA) or a low current (1 mA). In the high current (5 mA) experiment, two identical cathodes were discharged with one exposed to bubbling O₂ (air breathing cathode green tracing) and one having the solution purged with N₂ magenta tracing). The charges are very similar. Thus, at the higher currents, the influence of O₂ was not observed. In a low current (1 mA) experiment, two identical cathodes were discharged with one exposed to bubbling O₂ (blue trace) and one having the solution purged with N₂ (red trace). In this case, the additional charge available from the air-breathing cathode was observed as a prolonged time at less negative potentials.

### DETAILED DESCRIPTION

### Definitions

The term “power density” as used herein, refers to the calculation of mW/cm², wherein a watt (W) is amps time voltage. The calculation of area (in cm²) is made from the smaller area of the anode or the cathode in the disclosed fuel cell. The present disclosure fuel cell achieved a hereinbefore never achieved power density of greater than 10 mW/cm², preferably greater than 15 mW/cm², preferably greater than 20 mW/cm², or preferably greater than 25 mW/cm².

The term “catalyst loading” refers to the weight of the catalyst material added to the anode electrode or electrode per unit area (of anode or cathode).

The disclosure provides a battery or semi-fuel cell cathode. More particularly, the present disclosure provides a gelled cathode having a nitro-containing compound as the fuel in a gelled formulation.

A general method for making cathodes containing aromatic nitro compounds comprises producing cathodes that contain various combinations of at least the reducible material (e.g., the nitro compound, referred to herein as the “fuel”) and an electronic conductor (e.g., carbon or an inorganic oxide or sulfide that has sufficiently high electronic conductivity). In these cathodes the fuel may be reduced by a multi-electron process so that the aromatic nitro groups are reduced to amines, which would be a complete reduction. Alternatively, they may be reduced partially to give intermediate states of reduction, such as aromatic hydroxylamines. This ability to accept electrons, and especially to accept more than one electron per functional group (i.e., per aromatic nitro group), is a key attribute of the aromatic nitro compounds described herein. It is a unique aspect of aromatic nitro compounds that the nitro groups can be reduced by six electrons each to give amine groups. This ability to accept a large number of electrons per nitro group gives the aromatic nitro compounds a very large specific capacity (typically measured in amp hours per kilogram, A hr/kg). For example, 3,5-dinitrobenzamide (DNBA) has a specific capacity of 1,523 A hr/kg. This compares very favorably with LiCoO₂, the cathode material used in Sony's lithium battery technology, which has a specific capacity of approximately 140 A hr/kg.

The purpose of the electronic conductor is to make the pathway for electrons to travel through the bulk of the cathode structure sufficiently facile so that reduction of all of the fuel within the cathode may be accomplished. It also may have other properties as described below, such as the ability to catalyze or otherwise accelerate the reduction of the fuel. Preferred electronic conductors are carbon, inorganic oxides such as MnO₂ and V₂O₅ and sulfides such as TiS₂.

In addition to fuel and electronic conductor, the cathodes also may contain a binder, such as polytetrafluoroethylene (PTFE) or polyvinylidene difluoride (PVDF). The purpose of the binder is to provide cohesion for the cathode structure such that the fuel and electronic conductor remain in sufficiently good contact so that electrons may be delivered to the fuel to effect its reduction. The binder also may provide for adhesion of the cathode structure to the current collector, an example of which may be a stainless steel mesh that the cathode is held against or pressed into. The binder also may provide for facile transport of cations through the cathode structure. Transport of cations into and through the cathode during reduction is a requirement in order for electrical neutrality to be maintained within the cathode during the injection of electrons to reduce the fuel. Thus, the binder material provides for facile diffusion or electrical migration of cations into the interior of the cathode.

The cathode optionally also contains a species that serves to accelerate the reduction of the fuel. An example of such a species is electron mediator species that, themselves, may be reduced, and that subsequently delivers the electron to a fuel molecule somewhere within the cathode. Thus, the electron mediators serve the purpose of shuttling electrons between the current collector or the electronic conductor and the fuel. These species may be more than simple electron mediators, since they also may interact chemically with the aromatic nitro groups, thereby facilitating the bond reorganizations that allow the reduction of the nitro groups to produce intermediate species, such as the hydroxylamine species, or the final reduction production such, as amine groups. Examples of electron mediator species include, but are not limited to, viologen derivatives, such as N,N′-dibenzyl-4,4′-bipyridinium dications, iron phthalocyanine and its derivatives, cobalt phthalocyanine and its derivatives, various Cu salts, such as CuCl₂, and other compounds that are known to serve as redox mediators, such as Cu(bpy)₂Cl₂, where bpy is 2,2′bypyridine.

The cathode also may contain species that provide protons to the nitro groups that are needed to effect their reduction to amine groups. Specifically, for the six electron reduction of each nitro group to the fully reduced amine group, four protons are required, as shown in the following equation.

Ar—NO₂+4HB+6e⁻→Ar—NH₂+2OH⁻+4B⁻ (1)

In this equation HB represents a species whose purpose is to supply protons to allow for the reduction of the nitro groups to amine groups. Examples of such species include, but are not limited to, water, alcohols, acidic inorganic compounds (such as boric acid), acidic organic compounds (such as acetic acid), solid oxides that have acidic character (such as acid treated aluminum oxide), and the like.

The cathode also may contain other low or high molecular weight additives that serve to promote the transport of ionic species throughout the cathode. Examples of such compounds include, but are not limited to, polyethylene oxide of various molecular weights, polyethylene glycols of various molecular weights, diglyme, tetraglyme, crown ethers, and the like. These compounds function by providing sites at which cations may bind temporarily as they hop their way through the cathode material.

The cathode also may contain a solid salt, such as NaCl, Mg(ClO₄)₂, LiClO₄ and the like. The purpose of this salt is to provide for high ionic conductivity within the cathode as the solvent or supporting electrolyte floods the cathode and dissolves the salt.

The cathodes are typically prepared by measuring out the appropriate masses of the various components, adding the components together, and ball milling, grinding or in some other way reducing the particle size of the components to the range of 1-100 microns. The purpose of this is to produce a homogeneous powder that can then be formed into a cathode material. Following this homogenization, the cathode material is pressed directly into a pellet using a press and a die. It also may be mixed with a solvent such as n-methylpyrrolidone (NMP), made into a paste and then bladed into a thin film. This film is then dried and solidified by evaporative removal of the solvent, and free-standing disks may be cut of the cathode material. The pellets or disks produced by these methods are then pressed against a current collector, an example of which is a stainless steel mesh.

The disclosed cathodes are used in a variety of configurations to produce a battery capable of discharge. In a first configuration, the cathode-current collector may be immersed into a solution containing a dissolved salt, with the anode also in that same solution, some distance away from the cathode so as to prevent short circuits. The solution may be an aqueous electrolyte solutions, for example Mg(ClO₄)₂ dissolved in water, or it may be a non-aqueous solution, for example LiClO₄, dissolved in a non-aqueous solvent such as acetonitrile, propylene carbonate and the like. In a second configuration, the cathode is used in combination with a gel electrolyte. Gel electrolytes for use in solid-state batteries (that is, batteries that do not contain free-flowing, liquid solvents) have been described. They are typically comprised of polymers that have been impregnated with organic solvents, thereby forming a solid-like material. An example is polyvinylidene fluoride impregnated with ethylene carbonate or a mixture of several organic carbonate solvents. In this configuration, the cathode pellet or disk is placed against a gel electrolyte with an anode (such as Mg metal) pressed against the other side of the gel electrolyte film. In a third configuration, the cathode is placed adjacent to the anode, with a separator material placed between them so as to prevent short circuiting. Typically, this separator material is impregnated with a solvent or solvent mixture containing a dissolved salt. An example of such a mixture is a 50/50 (by weight) ethylene carbonate/propylene carbonate containing 1.0 M LiClO₄. Another example of a solvent mixture is an aqueous solution containing a dissolved salt, such as Mg(ClO₄)₂, LiClO₄, NaCl, LiCl and the like.

In a preferred embodiment of the present disclosure, the cathode is designed such that they admit air and thereby function as air cathodes, such as the cathodes used in metal-air batteries. In this configuration, the cathodes alternately operate by reduction of the fuel or by reduction of O₂ from the air. This allows the disclosed batteries to operate alternately as true batteries or as semi-fuel cells (that is, as air batteries), thereby potentially prolonging their lifetimes under conditions in which O₂ is available for reduction in place of the fuel. In addition, it is a surprising result to simultaneously reduce both fuel (such as DNBA (dinitorbenzoic acid)) and O₂ from the air such that the fuel usage efficiency is enhanced. For example, when cathodes such as those described herein are discharged, the total charge that can be extracted during the discharge in absence of O₂ is smaller than the theoretical value (i.e. the fuel usage efficiency is low.) Also, when fuel is left out of the cathode formulation (so as to perform a control experiment with a “control cathode”) and the control cathode is discharged in the presence of O₂, one observes very little total charge that can be extracted during the discharge. However, when both fuel and O₂ are present, more charge can be extracted during the discharge process. Specifically, the fuel usage efficiency is improved compared to the case in which no O₂ is present. Thus, the fuel reduction and the O₂ reduction appear to act synergistically, thereby providing a discharge performance that is improved compared to that in the absence of O₂.

### Example 1

This example illustrates the preparation of a cathode according to the present disclosure. In a first example, a cathode with the following composition was prepared by mixing together the following materials:

0.55 g DNBA (3,5-dinitrobenzamide)
0.30 g carbon (a 50/50 mixture of Vulcan XC-75 and Ketjen Black)
0.05 g PTFE (1 micron particle size)

### 0.10 g Mg(ClO₄)₂

The resulting powder mixture was added to a tube with glass spheres and pulverized by rapid back and forth motion in a ball mill device, but could also have been done on a rocker arm device. After being pulverized and homogenized, the powder was separated from the glass spheres. A small amount (0.01 g) was added to a die and compressed at a pressure of 10 tons cm⁻² for ten minutes. This produced a pellet with a diameter of around 13 mm. The pellet was compressed against a stainless steel mesh at a pressure of 12 tons cm⁻² for ten minutes, causing the pellet to be pressed into the current collector such that it forms a single, cohesive object. This cathode-current collector combination was then placed into a vessel containing an aerated, aqueous solution of 1.0 M Mg(ClO₄)₂. An anode comprising a 2 mm thick, 1 cm² piece of Mg alloy (AZ31) was also placed into the aqueous solution approximately 1 cm away from the cathode to form a battery system.

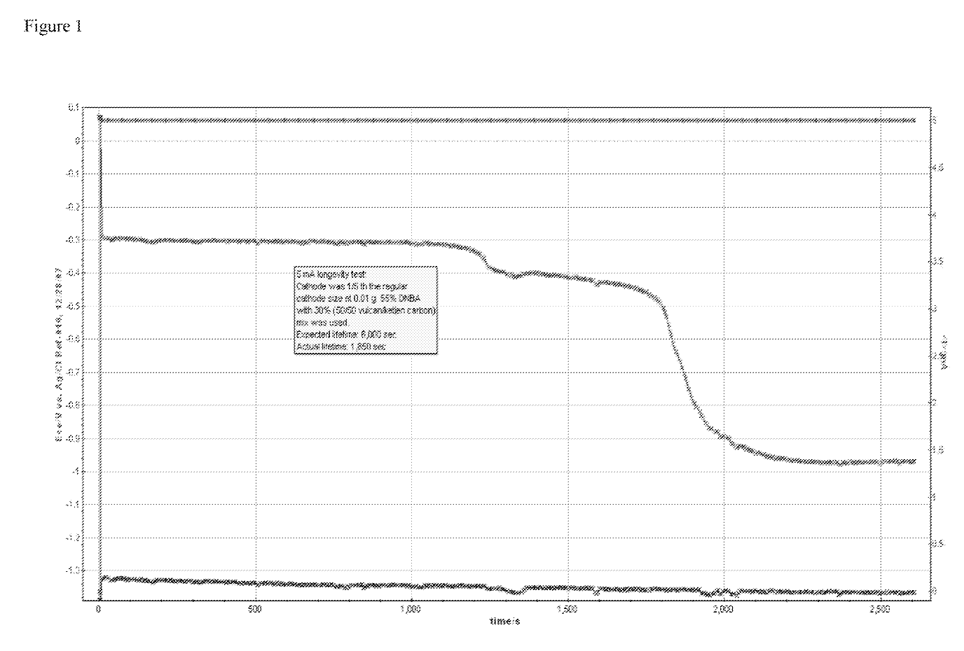

The battery system was ready to be discharged. FIG. 1 shows an example of a discharge curve from the battery system of Example 1. The battery was discharged at a constant rate of 5 mA (green curve in the figure). Both the cathode and anode potentials were measured against an Ag/AgCl reference electrode containing 4 M KCl. The anode potential is shown in blue, and the cathode potential is shown in red. As can be seen, the anode potential remained relatively constant at approximately −1.35 V. The cathode potential initially was also relatively constant at −0.3 V.

Thus, the battery output in the case was 1.05 V at a current of 5 mA. Based on the mass of cathode fuel (DNBA) in this cathode, at a constant current of 5 mA the expected time required for full reduction of all of the DNBA nitro groups to amine groups was 6,000 seconds. As can be seen, the cathode potential remained relatively constant at −0.3 V for approximately 1200 seconds, then changed to a value of −0.4 to −0.45 V until the total time reached 1800-1850 seconds. At that time the cathode potential became substantially more negative, indicating that the reduction of the fuel has ceased to control the cathode potential. At this new potential (<−0.9 V) the cathode was simply reducing water. Thus, in such a condition the battery became spent. Using the observed time for fuel reduction of 1800 seconds and the theoretical time expected of 6000 seconds one can compute a fuel usage efficiency of 1800/6000 was 30%.

### Example 2

In a second example, a cathode with the following composition was prepared:

0.55 g DNBA (3,5-dinitrobenzamide)
0.30 g carbon (Ketjen Black)
0.05 g PTFE (1 micron particle size)

### 0.10 g Mg(ClO₄)₂

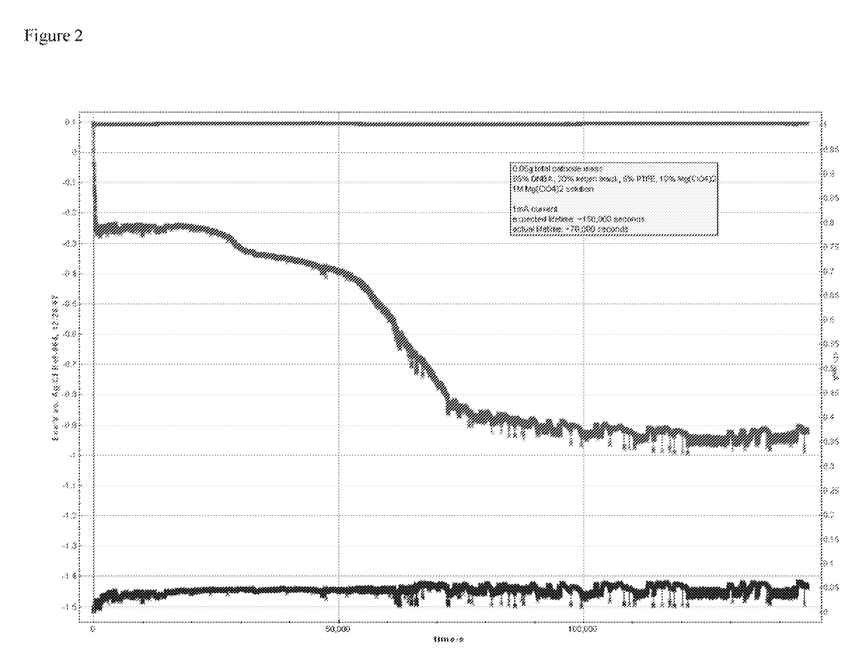

The procedure to make the cathode was the same one used in Example 1 herein, except that 0.05 g of the homogenized mixture was pressed together to make the cathode. This cathode/anode pair was discharged at a current of 1 mA. Based on this current and the mass of DNBA in the cathode, one calculates that this cathode should have theoretically remained with a stable output voltage for approximately 150,000 seconds. As can be seen from FIG. 2, the cathode potential remained relative stable with an output voltage of between −0.25 V and −0.45 V for approximately 60,000 seconds. This indicates a fuel usage efficiency of 40%. In contrast, fuel usage in N₂ sparged solutions that contained little dissolved O₂ gave fuel usages that are substantially less. This demonstrates the utility of simultaneous reduction of O₂ and the aromatic nitro fuels and the resulting synergistic effect this has on fuel usage efficiency.

### Example 3

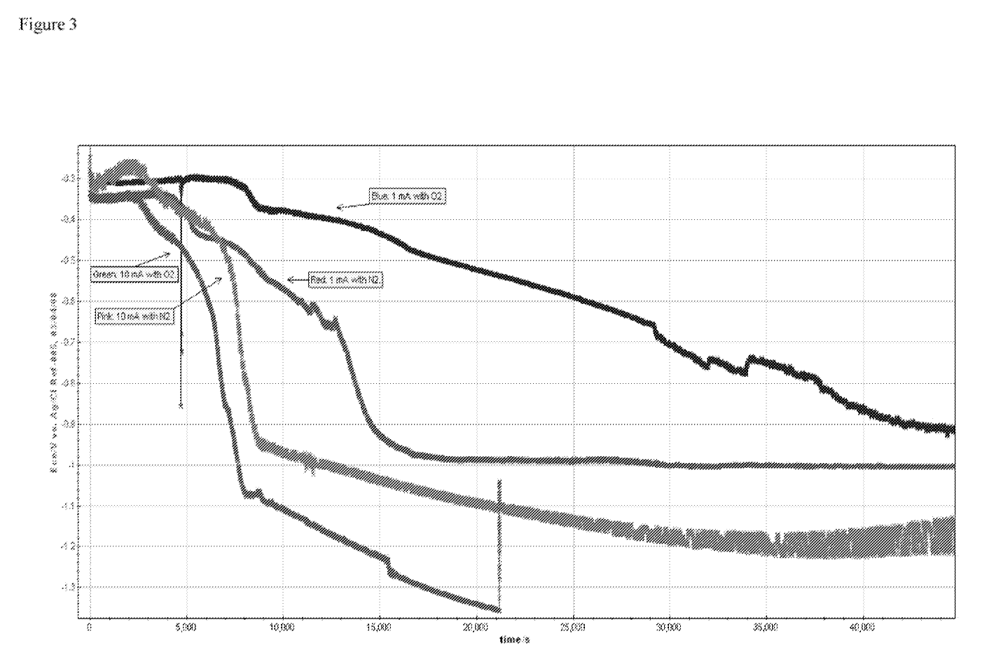

The charge enhancement available when the system is run in the presence of O₂ is larger at lower currents. This can be seen in FIG. 3. In FIG. 3, two sets of battery systems were operated at two different currents. In the first experiment, two identical cathodes were discharged at high current (5 mA), with one exposed to bubbling O₂ and one having the solution purged with N₂. The cathode potential traces for these experiments are colored green and magenta, respectively. As can be seen in FIG. 3, the charges are very similar. Thus, at the higher currents, the influence of O₂ was not observed. In a second experiment, two identical cathodes were discharged at low current (1 mA), with one exposed to bubbling O₂ (blue trace) and one having the solution purged with N₂ (red trace) (see FIG. 3). In this case, the additional charge available from the air-breathing cathode can clearly be observed as a prolonged time at less negative potentials. For example, the air breathing cathode remains at potentials above −0.6 V for more than 25,000 seconds, while the cathode under the N₂ atmosphere drops past this potential at a time of 11,000 seconds. Thus, at lower currents, the air breathing cathode provides more than twice as much charge as the cathode operated under N₂.

We claim:

1. A semi-fuel cell or battery cathode formulation comprising components (a) an aromatic nitro compound as a fuel, (b) a binder agent, and (c) and a conductive particle composition, wherein components (a), (b) and (c) are mixed together and pressed onto a scaffold to form a cathode.

2. The semi-fuel cell of battery cathode formulation of claim 1 wherein the aromatic nitro composition is an aromatic compound having at least one benzyl ring structure and from one to about 8 nitro (—NO₂) moieties. More preferably, the aromatic nitro composition having one or a plurality of fused benzyl rings, wherein when there is one benzyl group the compound is a compound selected from the group consisting of mono-, di-, or tri-nitrobenzene or nitrotoluene or nitro alkyl (C-16) benzyl or nitrobenzonitrile or nitrobenzotrifluoride or nitrobenzoic acid or nitrobenzenesulfonic acid; m- or p-nitro benzamine or benzoic acid, and combinations thereof, or when there is a plurality of fused rings, the compound is selected from the group consisting of one or a plurality of nitro moieties on a napththalene, anthracene and combinations thereof.

3. The semi-fuel cell of battery cathode formulation of claim 2 wherein the aromatic nitro compound is selected from the group consisting of 3,5-dinitrobenzamide, 2,6-dinitrobenzaldehyde, 1,2-dinitrobenzene, 1,3-dinitrobenzene, 1,4-dinitrobenzene, 2,4-dinitrobenzenesulfonic acid, 2,4-dinitrobenzoic acid, 3,5-dinitrobenzoic acid, 2,4-dinitrobensonitrile, 3,5-dinitrobenzonitrile, 2,5-dinitrobenzotrifluoride, and combinations thereof.

4. The semi-fuel cell of battery cathode formulation of claim 1 wherein the binder agent is present in an amount of from about 2% to about 10% by weight and the binder agent is selected from the group consisting of PEG (polyethylene glycol), PTFE (Teflon), other polyfluorinated elthylene polymers, n-methylpyrrolidone, conductive polymers such as polythiophenes, polypyrrolidones, polymers impregnated with organic solvents such as polyvinylidene fluoride impregnated with ethylene carbonate, carbonates, and combinations thereof.

5. The semi-fuel cell of battery cathode formulation of claim 1 wherein the conductive particle composition is selected from the group consisting of carbon, MnO₂, Vd oxide, and combinations thereof, and when carbon, is present at an amount of from about 25% to about 40% by weight, and when it is MnO₂ or Vd oxide or a combination of both present at an amount of from about 5% to about 10% by weight, the amount of carbon is from 0% to about 10% by weight.

6. The semi-fuel cell of battery cathode formulation of claim 1 wherein the cathode formulation further comprises a species that provides protons to the nitro groups to effect their reduction into amine groups, wherein the species that provides protons to the nitro groups is selected from the group consisting of water, mono or di (hydroxyl) C1-6 alkyl alcohols, boric acid, acetic acid, citric acid, maleic acid, malic acid, acid-treated aluminum oxide, and combinations thereof.

7. The semi-fuel cell of battery cathode formulation of claim 1 wherein the cathode formulation further comprises a low or high molecular weight additive that serves to promote the transport of ionic species throughout the cathode, wherein the low or high molecular weight additive that serves to promote the transport of ionic species throughout the cathode is selected from the group consisting of polyethylene oxide, polyethylene glycols, diglyme, tetraglyme, crown ethers, and combinations thereof.

8. The semi-fuel cell of battery cathode formulation of claim 1 wherein the cathode formulation further comprises a solid salt to provide for higher ionic conductivity within the cathode, and wherein the solid salt to provide for higher ionic conductivity within the cathode is selected from the group consisting of NaCl, Mg(ClO₄)₂, LiClO₄, MgCl₂, MgBr₂, LiF, LiCl, NaF, NaClO₄, and combinations thereof.

9. The semi-fuel cell of battery cathode formulation of claim 1 wherein the cathode formulation further comprises oxygen or openings to allow for air to circulate.

10. A battery having an anode and a cathode formulation, wherein the anode comprises a formulation of metals and alloys selected from the group consisting of Li, Mg, Ca, Al, and combinations thereof, and the cathode formulation comprises components (a) an aromatic nitro compound as a fuel, (b) a binder agent, and (c) and a conductive particle composition, wherein the components (a), (b) and (c) are mixed together and pressed onto a scaffold to form a cathode.

11. The battery having an anode and a cathode formulation of claim 10, wherein the aromatic nitro composition is an aromatic compound having at least one benzyl ring structure and from one to about 8 nitro (—NO₂) moieties, and wherein the aromatic nitro composition having one or a plurality of fused benzyl rings, wherein when there is one benzyl group the compound is a compound selected from the group consisting of mono-, di-, or tri-nitrobenzene or nitrotoluene or nitro alkyl (C-16) benzyl or nitrobenzonitrile or nitrobenzotrifluoride or nitrobenzoic acid or nitrobenzenesulfonic acid; m- or p-nitro benzamine or benzoic acid, and combinations thereof, or when there is a plurality of fused rings, the compound is selected from the group consisting of one or a plurality of nitro moieties on a napththalene, anthracene and combinations thereof.

12. The battery having an anode and a cathode formulation of claim 11, wherein the aromatic nitro compound is selected from the group consisting of 3,5-dinitrobenzamide, 2,6-dinitrobenzaldehyde, 1,2-dinitrobenzene, 1,3-dinitrobenzene, 1,4-dinitrobenzene, 2,4-dinitrobenzenesulfonic acid, 2,4-dinitrobenzoic acid, 3,5-dinitrobenzoic acid, 2,4-dinitrobensonitrile, 3,5-dinitrobenzonitrile, 2,5-dinitrobenzotrifluoride, and combinations thereof.

13. The battery having an anode and a cathode formulation of claim 10, wherein the binder agent is present in an amount of from about 2% to about 10% by weight and wherein the binder agent is selected from the group consisting of PEG (polyethylene glycol), PTFE (Teflon), other polyfluorinated elthylene polymers, n-methylpyrrolidone, conductive polymers such as polythiophenes, polypyrrolidones, polymers impregnated with organic solvents such as polyvinylidene fluoride impregnated with ethylene carbonate, carbonates, and combinations thereof.

14. The battery having an anode and a cathode formulation of claim 10, wherein the conductive particle composition is selected from the group consisting of carbon, MnO₂, Vd oxide, and combinations thereof, and wherein when the conductive particle composition is carbon, it present at an amount of from about 25% to about 40% by weight, or wherein when the conductive particle composition is MnO₂ or Vd oxide or a combination of both present at an amount of from about 5% to about 10% by weight, the amount of carbon is from 0% to about 10% by weight.

15. The battery having an anode and a cathode formulation of claim 10, wherein the cathode formulation further comprises a species that provides protons to the nitro groups to effect their reduction into amine groups, and wherein the species that provides protons to the nitro groups is selected from the group consisting of water, mono or di (hydrozyl) C1-6 alkyl alcohols, boric acid, acetic acid, citric acid, maleic acid, malic acid, acid-treated aluminum oxide, and combinations thereof.

16. The battery having an anode and a cathode formulation of claim 10, wherein the cathode formulation further comprises a low or high molecular weight additive that serves to promote the transport of ionic species throughout the cathode, and wherein the low or high molecular weight additive that serves to promote the transport of ionic species throughout the cathode is selected from the group consisting of polyethylene oxide, polyethylene glycols, diglyme, tetraglyme, crown ethers, and combinations thereof.

17. The battery having an anode and a cathode formulation of claim 10, wherein the cathode formulation further comprises a solid salt to provide for higher ionic conductivity within the cathode, and wherein the solid salt to provide for higher ionic conductivity within the cathode is selected from the group consisting of NaCl, Mg(ClO₄)₂, LiClO₄, MgCl₂, MgBr₂, LiF, LiCl, NaF, NaClO₄, and combinations thereof.

18. The battery having an anode and a cathode formulation of claim 10, wherein the cathode formulation further comprises oxygen or openings to allow for air to circulate.

19. An air-breathing cathode semi-fuel cell having an anode and a cathode formulation, wherein the anode comprises a formulation of metals and alloys selected from the group consisting of Li, Mg, Ca, Al, and combinations thereof, and the cathode formulation comprises components (a) an aromatic nitro compound as a fuel, (b) a binder agent, and (c) and a conductive particle composition, wherein the components (a), (b) and (c) are mixed together and pressed onto a scaffold to form a cathode, wherein the cathode formulation further comprises oxygen or openings to allow for air to circulate.

20. The air-breathing cathode semi-fuel cell having an anode and a cathode formulation of claim 19, wherein the aromatic nitro composition is an aromatic compound having at least one benzyl ring structure and from one to about 8 nitro (—NO₂) moieties, and wherein the aromatic nitro composition having one or a plurality of fused benzyl rings, wherein when there is one benzyl group the compound is a compound selected from the group consisting of mono-, di-, or tri-nitrobenzene or nitrotoluene or nitro alkyl (C-16) benzyl or nitrobenzonitrile or nitrobenzotrifluoride or nitrobenzoic acid or nitrobenzenesulfonic acid; m- or p-nitro benzamine or benzoic acid, and combinations thereof, or when there is a plurality of fused rings, the compound is selected from the group consisting of one or a plurality of nitro moieties on a napththalene, anthracene and combinations thereof.

21. The air-breathing cathode semi-fuel cell having an anode and a cathode formulation of claim 19, wherein the aromatic nitro compound is selected from the group consisting of 3,5-dinitrobenzamide, 2,6-dinitrobenzaldehyde, 1,2-dinitrobenzene, 1,3-dinitrobenzene, 1,4-dinitrobenzene, 2,4-dinitrobenzenesulfonic acid, 2,4-dinitrobenzoic acid, 3,5-dinitrobenzoic acid, 2,4-dinitrobensonitrile, 3,5-dinitrobenzonitrile, 2,5-dinitrobenzotrifluoride, and combinations thereof.

22. The air-breathing cathode semi-fuel cell having an anode and a cathode formulation of claim 19, wherein the binder agent is present in an amount of from about 2% to about 10% by weight, and wherein the binder agent is selected from the group consisting of PEG (polyethylene glycol), PTFE (Teflon), other polyfluorinated elthylene polymers, n-methylpyrrolidone, conductive polymers such as polythiophenes, polypyrrolidones, polymers impregnated with organic solvents such as polyvinylidene fluoride impregnated with ethylene carbonate, carbonates, and combinations thereof.

23. The air-breathing cathode semi-fuel cell having an anode and a cathode formulation of claim 19, wherein the conductive particle composition is selected from the group consisting of carbon, MnO₂, Vd oxide, and combinations thereof, and wherein when the conductive particle composition is carbon, it present at an amount of from about 25% to about 40% by weight, or wherein when the conductive particle composition is MnO₂ or Vd oxide or a combination of both present at an amount of from about 5% to about 10% by weight, the amount of carbon is from 0% to about 10% by weight.

24. The air-breathing cathode semi-fuel cell having an anode and a cathode formulation of claim 19, wherein the cathode formulation further comprises a species that provides protons to the nitro groups to effect their reduction into amine groups, and wherein the species that provides protons to the nitro groups is selected from the group consisting of water, mono or di (hydroxyl) C1-6 alkyl alcohols, boric acid, acetic acid, citric acid, maleic acid, malic acid, acid-treated aluminum oxide, and combinations thereof.

25. The air-breathing cathode semi-fuel cell having an anode and a cathode formulation of claim 19, wherein the cathode formulation further comprises a low or high molecular weight additive that serves to promote the transport of ionic species throughout the cathode, and wherein the low or high molecular weight additive that serves to promote the transport of ionic species throughout the cathode is selected from the group consisting of polyethylene oxide, polyethylene glycols, diglyme, tetraglyme, crown ethers, and combinations thereof.

26. The air-breathing cathode semi-fuel cell having an anode and a cathode formulation of claim 19, wherein the cathode formulation further comprises a solid salt to provide for higher ionic conductivity within the cathode, and wherein the solid salt to provide for higher ionic conductivity within the cathode is selected from the group consisting of NaCl, Mg(ClO₄)₂, LiClO₄, MgCl₂, MgBr₂, LiF, LiCl, NaF, NaClO₄, and combinations thereof.
